(19) United States
(12) Patent Application Publication
(10) Pub. No.: US 2025/0165779 A1
(43) Pub. Date: May 22, 2025

(54) A data processing system comprising a network, a method, and a computer program product

(71) Applicant: IntuiCell AB, Stockholm (SE)

(72) Inventors: Henrik Jörntell, Lund (SE); Linus Mårtensson, Malmö (SE); Udaya Bahskar Rongala, Lund (SE); Jonas Enander, Linkoping (SE)

(21) Appl. No.: 18/840,928

(22) PCT Filed: Feb. 21, 2023
(86) PCT No.: PCT/SE2023/050153

§ 371 Date: Aug. 23, 2024

Related U.S. Application Data
(60) Provisional application No. 63/313,076, filed on Feb. 23, 2022.

(30) Foreign Application Priority Data
Mar. 30, 2022 (SE) 2250397-3

(51) Int. Cl. G06N 3/08

(52) U.S. Cl. CPC G06N 3/08

(57) ABSTRACT

The disclosure relates to a data processing system (100), configured to have one or more system input(s) (110a, 110b, . . . , 110z) comprising data to be processed and a system output (120), comprising: a network, NW, (130) comprising a plurality of nodes (130a, 130b, . . . , 130x), each node configured to have a plurality of inputs (132a, 132b, . . . , 132y), each node (130a, 130b, . . . , 130x) comprising a weight (Wa, . . . , Wy) for each input (132a, 132b, . . . , 132y), and each node configured to produce an output (134a, 134b, . . . , 134x); and one or more updating units (150) configured to update the weights (Wa, . . . , Wy) of each node based on correlation of each respective input (132a, . . . , 132c) of the node (130a) with the corresponding output (134a) during a learning mode; one or more processing units (140x) configured to receive a processing unit input and configured to produce a processing unit output by changing the sign of the received processing unit input; and wherein the system output (120) comprises the outputs (134a, 134b, . . . , 134x) of each node (130a, 130b, . . . , 130x), wherein nodes (130a, 130b) of a first group (160) of the plurality of nodes are configured to excite one or more other nodes ( . . . , 130x) of the plurality of nodes (130a, 130b, . . . , 130x) by providing the output (134a, 134b) of each of the nodes (130a, 130b) of the first group (160) of nodes as input (132d, . . . , 132y) to the one or more other nodes ( . . . , 130x), wherein nodes (130x) of a second group (162) of the plurality of nodes are configured to inhibit one or more other nodes (130a, 130b, . . . ) of the plurality of nodes (130a, 130b, . . . , 130x) by providing the output (134x) of each of the nodes (130x) of the second group (162) as a processing unit input to a respective processing unit (140x), each respective processing unit (140x) being configured to provide the processing unit output as input (132b, 132e, . . . ) to the one or more other nodes (130a, 130b, . . . ) and wherein each node of the plurality of nodes (130a, 130b, . . . , 130x) belongs to one of the first and second groups (160, 162) of nodes. The disclosure further relates to a method, and a computer program product.

### TECHNICAL FIELD

The present disclosure relates to a data processing system comprising a network, a method, and a computer program product. More specifically, the disclosure relates to a data processing system comprising a network, a method and a computer program product as defined in the introductory parts of the independent claims.

### BACKGROUND ART

Artificial intelligence (AI) is known. One example of AI is Artificial Neural Networks (ANNs). ANNs can suffer from rigid representations that appear to make the network focusing on limited features for identification. Such rigid representations may lead to inaccuracy in predictions. Thus, it may be advantageous to create networks/data processing systems that do not rely on rigid representations, such as networks/data processing systems in which inference is instead based on widespread representations across all nodes/elements, and/or in which no individual features are allowed to become too dominant, thereby providing more accurate predictions and/or more accurate data processing systems. Networks in which all nodes contribute to all representations are known as dense coding networks. So far, implementations of dense coding networks have been hampered by a lack of rules for autonomous network formation, making it difficult to generate functioning networks with high capacity/variation.

Therefore, there may be a need for an AI system with increased capacity. processing. Preferably, such AI systems provide or enable one or more of improved performance, higher reliability, increased efficiency, faster training, use of less computer power, use of less training data, use of less storage space, less complexity and/or use of less energy.

SE 2051375 A1 mitigates some of the above-mentioned problems. However, there may still be a need for more efficient AI/data processing systems and/or alternative approaches.

### SUMMARY

An object of the present disclosure is to mitigate, alleviate or eliminate one or more of the above-identified deficiencies and disadvantages in prior art and solve at least the above-mentioned problem(s).

According to a first aspect there is provided a data processing system. The data processing system is configured to have one or more system inputs comprising data to be processed and a system output. The data processing system comprises: a network, NW, comprising a plurality of nodes, each node configured to have a plurality of inputs, each node comprising a weight for each input, and each node configured to produce an output; and one or more updating units configured to update the weights of each node based on correlation of each respective input of the node with the corresponding output during a learning mode; one or more processing units configured to receive a processing unit input and configured to produce a processing unit output by changing the sign of the received processing unit input. The system output comprises the outputs of each node. Furthermore, nodes of a first group of the plurality of nodes are configured to excite one or more other nodes of the plurality of nodes by providing the output of each of the nodes of the first group of nodes as input to the one or more other nodes. Moreover, nodes of a second group of the plurality of nodes are configured to inhibit one or more other nodes of the plurality of nodes by providing the output of each of the nodes of the second group as a processing unit input to a respective processing unit, each respective processing unit being configured to provide the processing unit output as input to the one or more other nodes. Each node of the plurality of nodes belongs to one of the first and second groups of nodes.

According to some embodiments, the system inputs comprises sensor data of a plurality of contexts/tasks.

According to some embodiments, the updating unit comprises, for each weight, a probability value for increasing the weight, and during the learning mode, the data processing system is configured to limit the ability of a node to inhibit or excite the one or more other nodes by providing a first set point for a sum of all weights associated with the inputs to the one or more other nodes, comparing the first set point to the sum of all weights associated with the inputs to the one or more other nodes, if the first set point is smaller than the sum of all weights associated with the inputs to the one or more other nodes decreasing the probability values associated with the weights associated with the inputs to the one or more other nodes and if the first set point is greater than the sum of all weights associated with the inputs to the one or more other nodes increasing the probability values associated with the weights associated with the inputs to the one or more other nodes. Thereby, the uniqueness of every node is improved, the learning is improved/speeded up and/or the precision/accuracy is improved/increased.

According to some embodiments, during the learning mode, the data processing system is configured to limit the ability of a system input to inhibit or excite one or more nodes by providing the first set point for a sum of all weights associated with the inputs to the one or more nodes, comparing the first set point to the sum of all weights associated with the inputs to the one or more nodes, if the first set point is smaller than the sum of all weights associated with the inputs to the one or more nodes decreasing the probability values associated with the weights associated with the inputs to the one or more nodes and if the first set point is greater than the sum of all weights associated with the inputs to the one or more nodes increasing the probability values associated with the weights associated with the inputs to the one or more nodes. Thereby, the learning is improved/speeded up and/or the precision/accuracy is improved/increased.

According to some embodiments, each of the inputs to the one or more other nodes has a coordinate in a network space, and an amount of decreasing/increasing the weights of the inputs to the one or more other nodes is based on a distance between the coordinates of the inputs associated with the weights in the network space.

According to some embodiments, the system is further configured to set a weight to zero if the weight does not increase over a pre-set period of time.

According to some embodiments, the system is further configured to increase the the probability value of a weight having a zero value if the sum of all weights associated with the inputs to the one or more other nodes does not exceed the first set point for a pre-set period of time.

According to some embodiments, during the learning mode, the data processing system is configured to increase the relevance of the output of a node to the one or more other nodes by providing a first set point for a sum of all weights associated with the inputs to the one or more other nodes, comparing the first set point to the sum of all weights associated with the inputs to the one or more other nodes over a first time period, if the first set point is smaller than the sum of all weights associated with the inputs to the one or more other nodes over the entire length of the first time period increasing the probability of changing the weights of the inputs to the node and if the first set point is greater than the sum of all weights associated with the inputs to the one or more other nodes over the entire length of the first time period decreasing the probability of changing the weights of the inputs to the node. Thereby, the learning is improved/speeded up and/or the precision/accuracy is improved/increased.

According to some embodiments, the updating unit comprises, for each weight, a probability value for increasing the weight, and wherein, during the learning mode, the data processing system is configured to provide a second set point for a sum of all weights associated with the inputs to a node, configured to calculate the sum of all weights associated with the inputs to the node, configured to compare the calculated sum to the second set point and if the calculated sum is greater than the second set point, configured to decrease the probability values associated with the weights associated with the inputs to the node and if the calculated sum is smaller than the second set point, configured to increase the probability values associated with the weights associated with the inputs to the node. Thereby, the learning is improved/speeded up and/or the precision/accuracy is improved/increased.

According to some embodiments, each node comprises a plurality of compartments and each compartment is configured to have a plurality of compartment inputs, each compartment comprising a compartment weight for each compartment input, and each compartment is configured to produce a compartment output and each compartment comprises an updating unit configured to update the compartment weights based on correlation during the learning mode and the compartment output of each compartment is utilized to adjust the output of the node the compartment is comprised in based on a transfer function. Thereby, each single node is made more useful/powerful (e.g., the capacity is increased), the learning is improved/speeded up and/or the precision/accuracy is improved/increased.

According to some embodiments, during the learning mode, the data processing system is configured to: detect whether the network is sparsely connected by comparing an accumulated weight change for the system inputs over a second time period to a threshold value; and if the data processing system detects that the network is sparsely connected, increase the output of one or more of the plurality of nodes by adding a predetermined waveform to the output of one or more of the plurality of nodes for the duration of a third time period. Thereby, a more efficient data processing system, which can handle a wider range of contexts/tasks per the given amount of network resources, and thus reduced power consumption is achieved.

According to some embodiments, each node comprises an updating unit, each updating unit is configured to update the weights of the respective node based on correlation of each respective input of the node with the output of that node and each updating unit is configured to apply a first function to the correlation if the associated node belongs to the first group of the plurality of nodes and apply a second function, different from the first function, to the correlation if the associated node belongs to the second group of the plurality of nodes in order to update the weights during the learning mode. By updating the weights of the respective node based on correlation of each respective input of the node with the output of that (same) node, and applying a first function to the correlation if the associated node belongs to the first group of the plurality of nodes and applying a second function, different from the first function, to the correlation if the associated node belongs to the second group of the plurality of nodes in order to update the weights (during the learning mode), each node is made more independent of the other nodes, and a higher precision is obtained (compared to prior art, e.g., back propagation). Thus, a technical effect is that a higher precision/accuracy is achieved/obtained.

According to some embodiments, the data processing system is configured to, after updating of the weights has been performed, calculate a population variance of the outputs of the nodes of the network, compare the calculated population variance to a power law; and minimizing an error or a mean squared error between the population and the power law by adjusting parameters of the network. Thereby, each node is made more independent from other nodes (and a measure of how independent the nodes are from each other can be obtained). Thus, a more efficient data processing system, which can handle a wider range of contexts/tasks per the given amount of network resources, and thus reduced power consumption is achieved.

According to some embodiments, the data processing system is configured to from the sensor data learn to identify one or more entities while in a learning mode and thereafter configured to identify the one or more entities while in a performance mode and the identified entity is one or more of a speaker, a spoken letter, syllable, phoneme, word or phrase present in the sensor data or an object or a feature of an object present in sensor data or a new contact event, an end of a contact event, a gesture or an applied pressure present in the sensor data. In some embodiments, a higher precision/accuracy in identifying one or more entities or measurable characteristics thereof is achieved/obtained.

According to some embodiments, the network is a recurrent neural network.

According to some embodiments, the network is a recursive neural network.

According to a second aspect there is provided a computer-implemented or hardware-implemented method for processing data. The method comprises a) receiving one or more system inputs comprising data to be processed; b) providing a plurality of inputs, at least one of the plurality of inputs being a system input, to a network, NW, comprising a plurality of first nodes; c) receiving an output from each first node; d) providing a system output, comprising the output of each first node; e) exciting, by nodes of a first group of the plurality of nodes, one or more other nodes of the plurality of nodes by providing the output of each of the nodes of the first group of nodes as input to the one or more other nodes; f) inhibiting, by nodes of a second group of the plurality of nodes, one or more other nodes of the plurality of nodes by providing the output of each of the nodes of the second group as a processing unit input to a respective processing unit, each respective processing unit being configured to provide the processing unit output as input to the one or more other nodes; and g) optionally updating, by one or more updating units, weights based on correlation; h) optionally repeating a)-g) until a learning criterion is met; and i) repeating a)-f) until a stop criterion is met, and each node of the plurality of nodes belongs to one of the first and second groups of nodes.

According to some embodiments, the method further comprises initializing weights by setting the weights to zero and adding a predetermined waveform to the output of one or more of the plurality of nodes for the duration of a third time period, the third time period starting at the same time receiving one or more system inputs comprising data to be processed starts.

According to some embodiments, the method further comprises initializing weights by randomly allocating values between 0 and 1 to the weights and adding a predetermined waveform to the output of one or more of the plurality of nodes for the duration of a third time period

According to a third aspect there is provided a computer program product comprising a non-transitory computer readable medium, having stored thereon a computer program comprising program instructions, the computer program being loadable into a data processing unit and configured to cause execution of the method of the third aspect or any of the above mentioned embodiments when the computer program is run by the data processing unit.

Effects and features of the second and third aspects are to a large extent analogous to those described above in connection with the first aspect and vice versa. Embodiments mentioned in relation to the first aspect are largely compatible with the second and third aspects and vice versa.

An advantage of some embodiments is a more efficient processing of the data/information, e.g., during a learning/training mode.

A further advantage of some embodiments is that a more efficient network is provided, e.g., the utilization of available network capacity is maximized, thus providing a more efficient data processing system.

Another advantage of some embodiments is that the system/network is less complex, e.g., having fewer nodes (with the same precision and/or for the same context/input range).

Yet another advantage of some embodiments is a more efficient use of data.

A further advantage of some embodiments is that utilization of available network capacity is improved (e.g., maximized), thus providing a more efficient data processing system.

Yet a further advantage of some embodiments is that the system/network is more efficient and/or that training/learning is shorter/faster.

Another advantage of some embodiments is that a network with lower complexity is provided.

A further advantage of some embodiments is an improved/increased generalization (e.g., across different tasks/contexts).

Yet a further advantage of some embodiments is that the system/network is less sensitive to noise.

Other advantages of some of the embodiments are improved performance, higher/increased reliability, increased precision, increased efficiency (for training and/or performance), faster/shorter training/learning, less computer power needed, less training data needed, less storage space needed, less complexity and/or lower energy consumption.

In some embodiments, each node is made more independent of the other nodes. This leads to that the total capacity to represent information in the data processing system is increased (and thus that more information can be represented, e.g., in the data processing system or for identification of one or more entities/objects and/or one or more features of one or more objects), and therefore a higher precision is obtained (compared to prior art, e.g., back propagation).

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic block diagram illustrating a data processing system according to some embodiments;

FIG. 2 is a schematic block diagram illustrating a data processing system according to some embodiments;

FIG. 3 is a flowchart illustrating method steps according to some embodiments;

FIG. 4 is a schematic drawing illustrating an example computer readable medium according to some embodiments;

FIG. 5 is a schematic drawing illustrating an updating unit according to some embodiments; and

FIG. 6 is a schematic drawing illustrating a compartment according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a “node”. The term “node” may refer to a neuron, such as a neuron of an artificial neural network, another processing element, such as a processor, of a network of processing elements or a combination thereof. Thus, the term “network” (NW) may refer to an artificial neural network, a network of processing elements or a combination thereof.

Below is referred to a “processing unit”. A processing unit may also be referred to as a synapse, such as an input unit (with a processing unit) for a node. However, in some embodiments, the processing unit is a (general) processing unit (other than a synapse) associated with (connected to, connectable to or comprised in) a node of a NW, or a (general) processing unit located between two different nodes of the NW.

Below is referred to “context”. A context is the circumstances involved or the situation. Context relates to what type of (input) data is expected, e.g., different types of tasks, where every different task has its own context. As an example, if a system input is pixels from an image sensor, and the image sensor is exposed to different lighting conditions, each different lighting condition may be a different context for an object, such as a ball, a car, or a tree, imaged by the image sensor. As another example, if the system input is audio frequency bands from one or more microphones, each different speaker may be a different context for a phoneme present in one or more of the audio frequency bands.

Below is referred to “measurable”. The term “measurable” is to be interpreted as something that can be measured or detected, i.e., is detectable. The terms “measure” and “sense” are to be interpreted as synonyms.

Below is referred to “entity”. The term entity is to be interpreted as an entity, such as physical entity or a more abstract entity, such as a financial entity, e.g., one or more financial data sets. The term “physical entity” is to be interpreted as an entity that has physical existence, such as an object, a feature (of an object), a gesture, an applied pressure, a speaker, a spoken letter, a syllable, a phoneme, a word, or a phrase.

Below is referred to “updating unit”. An updating unit may be an updating module or an updating object.

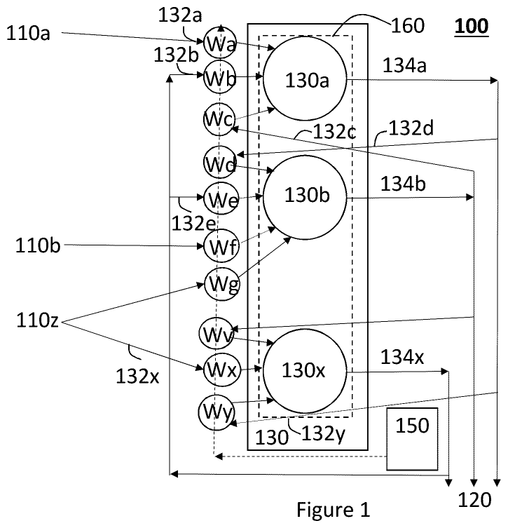

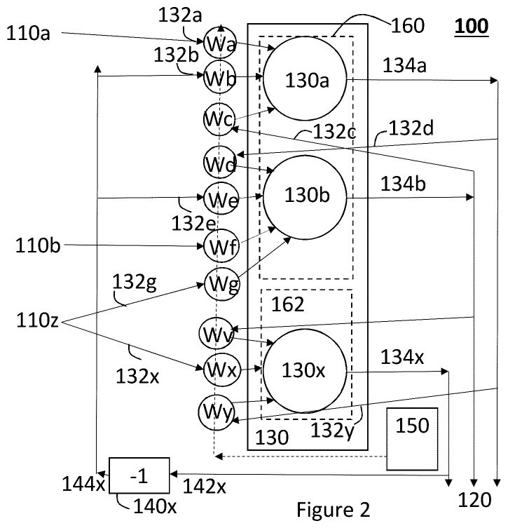

In the following, embodiments will be described where FIG. 1 is a schematic block diagram illustrating a data processing system 100 according to some embodiments and FIG. 2 is a schematic block diagram illustrating a data processing system 100 according to some embodiments. In some embodiments, the data processing system 100 is a network (NW) or comprises an NW. In some embodiments, the data processing system 100 is or comprises a deep neural network, a deep belief network, a deep reinforcement learning system, a recurrent neural network, or a convolutional neural network.

The data processing system 100 has, or is configured to have, one or more system inputs 110a, 110b, . . . , 110z. The one or more system inputs 110a, 110b, . . . , 110z comprises data to be processed. The data may be multidimensional. E.g., a plurality of signals is provided in parallel. In some embodiments, the system input 110a, 110b, . . . , 110z comprises or consists of time-continuous data. In some embodiments, the data to be processed comprises data from sensors, such as image sensors, touch sensors and/or sound sensors (e.g., microphones). Furthermore, in some embodiments, the one or more system inputs 110a, 110b, . . . , 110z comprises sensor data of a plurality of contexts/tasks, e.g., while the data processing system 100 is in a learning mode and/or while the data processing system 100 is in a performance mode. I.e., in some embodiments, the data processing system 100 is in a performance mode and a learning mode simultaneously.

Furthermore, the data processing system 100 has, or is configured to have, a system output 120. The data processing system 100 comprises a network (NW) 130. The NW 130 comprises a plurality of nodes 130a, 130b, . . . , 130x. Each node 130a, 130b, . . . , 130x has, or is configured to have, a plurality of inputs 132a, 132b, . . . , 132y. In some embodiments, at least one of the plurality of inputs 132a, 132b, . . . , 132y is a system input 110a, 110b, . . . , 110z. Furthermore, in some embodiments, all of the system inputs 110a, 110b, . . . , 110z are utilized as inputs 132a, 132b, . . . , 132y to one or more of the nodes 130a, 130b, . . . , 130x. Moreover, in some embodiments, each of the nodes 130a, 130b, . . . , 130x has one or more system inputs 110a, 110b, . . . , 110z as input(s) 132a, 132b, . . . , 132y. Each node 130a, 130b, . . . , 130x has or comprises a weight Wa, Wb, . . . , Wy for each input 132a, 132b, . . . , 132y, i.e., each input 132a, 132b, . . . , 132y is associated with a respective weight Wa, Wb, . . . , Wy. In some embodiments, each weight Wa, Wb, . . . , Wy has a value in the range from 0 to 1. Furthermore, the NW 130 Or each node thereof produces, or is configured to produce, an output 134a, 134b, . . . , 134x. In some embodiments, each node 130a, 130b, . . . , 130x calculates a combination, such as a (linear) sum, a squared sum, or an average, of the inputs 132a, 132b, . . . , 132y (to that node) multiplied by a respective weight Wa, Wb, . . . , Wy to produce the output(s) 134a, 134b, . . . , 134x.

The data processing system 100 comprises one or more updating units 150 configured to update the weights Wa, . . . , Wy of each node based on (in accordance with) correlation of each respective input 132a, . . . , 132c of a node (e.g., 130a) with the corresponding output (e.g., 134a), i.e., with the output of the same node (e.g., 130a), during a learning mode. In some embodiments, there is no updating of weights during a performance mode. In one example, updating of the weights Wa, Wb, Wc is based on (in accordance with) correlation of each respective input 132a, . . . , 132c to a node 130a with the combined activity of all inputs 132a, . . . , 132c to that node 130a, i.e., correlation of each respective input 132a, . . . , 132c to a node 130a with the output 134a of that node 130a (as an example for the node 130a and applicable to all other nodes 130b, . . . 130x). Thus, correlation (values) between a first input 132a and the respective output 134a is calculated, correlation (values) between a second input 132b and the respective output 134a is calculated, and correlation (values) between a third input 132c and the respective output 134a is calculated. In some embodiments, the different calculated correlation (series of) values are compared to each other, and the updating of weights is based on (in accordance with) this comparison. In some embodiments, updating the weights Wa, . . . , Wy of each node based on (in accordance with) correlation of each respective input (e.g., 132a, . . . , 132c) of a node (e.g., 130a) with the corresponding output (e.g., 134a) comprises evaluating each input (e.g., 132a, . . . , 132c) of a node (e.g., 130a) based on (in accordance with) a score function. The score function gives an indication of how useful each input (e.g., 132a, . . . , 132c) of a node (e.g., 130a) is spatially, e.g., for the corresponding output (e.g., 134a) compared to the other inputs (e.g., 132a, . . . , 132c) to that node, and/or temporally, e.g., over the time the data processing system (100) processes the input (e.g., 132a). As mentioned above, the updating of the weights Wa, . . . , Wy of each node is based on or in accordance with correlation of each respective input 132a, . . . , 132c of a node (e.g., 130a) with the corresponding output (e.g., 134a), i.e., with the output of the same node (only). Thus, the updating of the weights of each node is independent of updating/learning in other nodes, i.e., each node has independent learning.

Furthermore, the data processing system 100 comprises one or more processing units 140x configured to receive a processing unit input 142x and configured to produce a processing unit output 144x by changing the sign of the received processing unit input 142x. In some embodiments, the sign of the received processing unit input 142x is changed by multiplying the processing unit input 142x by −1. However, in other embodiments, the sign of the received processing unit input 142x is changed by phase-shifting the received processing unit input 142x 180 degrees. Alternatively, the sign of the received processing unit input 142x is changed by inverting the sign, e.g., from plus to minus or from minus to plus. The system output 120 comprises the outputs 134a, 134b, . . . , 134x of each node 130a, 130b, . . . , 130x. In some embodiments, the system output 120 is an array of outputs 134a, 134b, . . . , 134x. Furthermore, in some embodiments, the system output 120 is utilized to identify one or more entities or a measurable characteristic (or measurable characteristics) thereof while in a performance mode, e.g., from sensor data.

In some embodiments, the NW 130 comprises only a first group 160 of the plurality of nodes 130a, 130b, . . . , 130x (as seen in FIG. 1). However, in some embodiments the NW 130 comprises a first group 160 of the plurality of nodes 130a, 130b, . . . , 130x and a second group 162 of the plurality of nodes 130a, 130b, . . . , 130x (as seen in FIG. 2). Each of the nodes (e.g., 130a, 130b) of the first group 160 of the plurality of nodes (i.e., excitatory nodes) are configured to excite one or more other nodes (e.g., 130x) of the plurality of nodes 130a, 130b, . . . , 130x, such as all other nodes 130b, . . . , 130x, by providing the output (e.g., 134a, 134b) of each of the nodes (e.g., 130a, 130b) of the first group 160 of nodes (directly) as input (132d, . . . , 132y) to the one or more other nodes (e.g., 130x), such as to all other nodes 130b, . . . , 130x.

Furthermore, the nodes (e.g., 130x) of the second group 162 of the plurality of nodes are configured to inhibit one or more other nodes 130a, 130b, . . . , such as all other nodes 130a, 130b, . . . , of the plurality of nodes 130a, 130b, . . . , 130x by providing the output (e.g., 134x) of each of the nodes (e.g., 130x) of the second group 162 as a processing unit input 142x to a respective processing unit (e.g., 140x), each respective processing unit (e.g., 140x) being configured to provide the processing unit output 144x as input (e.g., 132b, 132e) to the one or more other nodes e.g., 130a, 130b). Each node of the plurality of nodes 130a, 130b, . . . , 130x belongs to one of the first and second groups (160, 162) of nodes. Furthermore, as indicated above, in some embodiments, all nodes 130a, 130b, . . . , 130x belong to the first group 160 of nodes. In some embodiments, each node 130a, 130b, . . . , 130x is configured to either inhibit or excite some/all other nodes 130b, . . . , 130x of the plurality of nodes 130a, 130b, . . . , 130x by providing the output 134a, 134b, . . . , 134x (of each node 130a, 130b, . . . , 130x) either multiplied by −1 or directly as an input 132d, . . . , 132y to one or more other nodes 130b, . . . , 130x. By configuring one group of nodes to inhibit other nodes and another group of nodes to excite other nodes and perform updating based on (in accordance with) correlation during the learning mode, a more efficient network may be provided, e.g., the utilization of available network capacity may be maximized, thus providing a more efficient data processing system.

In some embodiments, the updating unit(s) 150 comprises, for each weight Wa, . . . , Wy, a probability value Pa, . . . , Py for increasing the weight (and possibly a probability value Pad, . . . , Pyd for decreasing the weight which in some embodiments is 1−Pa, . . . , 1−Py, i.e., Pad=1−Pa, Pbd=1−Pb etc.). In some embodiments, the updating unit(s) 150 comprises look-up tables (LUTs) for storing the probability values Pa, . . . , Py. During the learning mode, the data processing system 100 is configured to limit the ability of a node (e.g., 130a) to inhibit or excite the one or more other nodes (e.g., 130b, . . . , 130x) by providing a first set point for a sum of all weights (e.g., Wd, Wy) associated with the inputs (e.g., 132d, . . . , 132y) to the one or more other nodes (e.g., 130b, . . . , 130x), by comparing the first set point to the sum of all weights (e.g., Wd, Wy) associated with the inputs (e.g., 132d, 132y) to the one or more other nodes (e.g., 130b, . . . , 130x), by, if the first set point is smaller than the sum of all weights (e.g., Wd, Wy) associated with the inputs (e.g., 132d, 132y) to the one or more other nodes (e.g., 130b, . . . , 130x), decreasing the probability values (e.g., Pd, Py) associated with the weights (e.g., Wd, Wy) for (associated with) the inputs (e.g., 132d, 132y) to the one or more other nodes (e.g., 130b, . . . , 130x) and, by, if the first set point is greater than the sum of all weights (e.g., Wd, Wy) associated with the inputs (e.g., 132d, 132y) to the one or more other nodes (e.g., 130b, . . . , 130x) increasing the probability values (e.g., Pd, Py) associated with the weights (e.g., Wd, Wy) for (associated with) the inputs (e.g., 132d, 132y) to the one or more other nodes (e.g., 130b, . . . , 130x).

Furthermore, in some embodiments, the data processing system 100 is, during the learning mode, configured to limit the ability of a system input (e.g., 110z) to inhibit or excite one or more nodes (e.g., 130b, 130x) by providing the first set point for a sum of all weights (e.g., Wg, Wx) associated with the inputs (e.g., 132g, 132x) to the one or more nodes (e.g., 130b, 130x), by comparing the first set point to the sum of all weights (e.g., Wg, Wx) associated with the inputs (e.g., 132g, 132x) to the one or more nodes (e.g., 130b, 130x), by, if the first set point is smaller than the sum of all weights (e.g., Wg, Wx) associated with the inputs (e.g., 132g, 132x) to the one or more nodes (e.g., 130b, 130x) decreasing the probability values (e.g., Pg, Px) associated with the weights (e.g., Wg, Wx) associated with the inputs (e.g., 132g, 132x) to the one or more nodes (e.g., 130b, 130x) and by, if the first set point is greater than the sum of all weights (e.g., Wg, Wx) associated with the inputs (e.g., 132g, 132x) to the one or more nodes (e.g., 130b, 130x) increasing the probability values (e.g., Pg, Px) associated with the weights (e.g., Wg, Wx) for (associated with) the inputs (e.g., 132g, 132x) to the one or more nodes (e.g., 130b, 130x).

Moreover, in some embodiments, each of the inputs (e.g., 132d, 132y) to the one or more other nodes (e.g., 130b, 130x) has a coordinate in a network space, and an amount of decreasing/increasing the weights (e.g., Wd, Wy) of the inputs (e.g., 132d, 132y) to the one or more other nodes (e.g., 130b, 130x) is based on (in accordance with) a distance between the coordinates of the inputs (e.g., 132d, 132y) associated with the weights (e.g., Wd, Wy) in the network space. In these embodiments, the decreasing/increasing of the weights is based on (in accordance with) the probability (indicated by the probability values) of decreasing/increasing the weights and based on (in accordance with) the amount to decrease/increase the weights (which is calculated based on the distance in the network space between the coordinates of the inputs.

In some embodiments, the data processing system 100 is (further) configured to set a weight Wa, . . . , Wy (e.g., any of one or more of the weights) to zero if the weight Wa, . . . , Wy (in question) does not increase over a (first) pre-set period of time. Furthermore, in some embodiments, the data processing system 100 is (further) configured to increase the probability value Pa, . . . , Py of a weight Wa, . . . , Wy having a zero value if the sum of all weights (e.g., Wd, Wy) associated with the inputs (e.g., 132d, 132y) to the one or more other nodes (e.g., 130b, 130x) does not exceed the first set point for a (second) pre-set period of time.

In some embodiments, the data processing system 100 is, during the learning mode, configured to increase the relevance of the output (e.g., 134a) of a node (e.g., 130a) to the one or more other nodes (e.g., 130b, 130x) by providing a first set point for a sum of all weights (e.g., Wd, Wy) associated with the inputs (e.g., 132d, 132y) to the one or more other nodes (e.g., 130b, 130x), by comparing the first set point to the sum of all weights (e.g., Wd,

Wy) associated with the inputs (e.g., 132d, 132y) to the one or more other nodes (e.g., 130b, 130x) over a first time period, by, if the first set point is smaller than the sum of all weights (e.g., Wd, Wy) associated with the inputs (e.g., 132d, 132y) to the one or more other nodes (e.g., 130b, 130x) over the entire length of the first time period increasing the probability of changing the weights (e.g., Wa, Wb, Wc) of the inputs (e.g., 132a, 132b, 132c) to the node (e.g., 130a) and, by, if the first set point is greater than the sum of all weights (e.g., Wd, Wy) associated with the inputs (e.g., 132d, 132y) to the one or more other nodes (e.g., 130b, 130x) over the entire length of the first time period decreasing the probability of changing the weights (e.g., Wa, Wb, Wc) of the inputs (e.g., 132a, 132b, 132c) to the node (e.g., 130a) (and in the rare occasion that the first set point is neither smaller nor greater than the sum of all weights during entire length of the first time period leave the probability of changing the weights unchanged).

Furthermore, in some embodiments, the updating unit(s) 150 comprises, for each weight Wa, . . . , Wy, a probability value Pa, . . . , Py for increasing the weight (and possibly a probability value Pad, . . . , Pyd for decreasing the weight which in some embodiments is 1−Pa, . . . , 1−Py, i.e., Pad=1−Pa, Pbd=1−Pb etcetera). In these embodiments, during the learning mode, the data processing system 100 is configured to provide a second set point for a sum of all weights Wa, Wb, Wc associated with the inputs 132a, 132b, 132c to a node 130a, configured to calculate the sum of all weights Wa, Wb, Wc associated with the inputs 132a, 132b, 132c to the node 130a, configured to compare the calculated sum to the second set point and if the calculated sum is greater than the second set point, configured to decrease the probability values Pa, Pb, Pc associated with the weights Wa, Wb, Wc for (associated with) the inputs 132a, 132b, 132c to the node 130a and if the calculated sum is smaller than the second set point, configured to increase the probability values Pa, Pb, Pc associated with the weights Wa, Wb, Wc for (associated with) the inputs 132a, 132b, 132c to the node 130a (as an example for the node 130a and also applicable to all other nodes 130b, . . . , 130x).

Moreover, in some embodiments, during the learning mode, the data processing system 100 is configured to detect whether the network 130 is sparsely connected by comparing an accumulated weight change for the one or more system inputs 110a, 110b, . . . , 110z to a threshold value over a second time period. The accumulated weight change is the change of the weights Wa, Wf, Wg, Wx associated with the one or more system inputs 110a, 110b, . . . , 110z over a second time period. The second time period may be a predetermined time period. If the accumulated weight change is greater than the threshold value, it is determined that the network 130 is sparsely connected. Furthermore, the data processing system 100 is configured to, if the data processing system 100 detects that the network 130 is sparsely connected, increase the output 134a, 134b, . . . , 134x of one or more of the plurality of nodes 130a, 130b, . . . , 130x by adding a predetermined waveform to the output 134a, 134b, . . . , 134x of one or more of the plurality of nodes 130a, 130b, . . . , 130x for the duration of a third time period. The third time period may be a predetermined time period. By adding a predetermined waveform to the output 134a, 134b, . . . , 134x of one or more of the plurality of nodes 130a, 130b, . . . , 130x for the duration of a third time period, nodes may be better grouped together.

Moreover, in some embodiments, each node comprises an updating unit 150. Each updating unit 150 is configured to update the weights Wa, Wb, Wc of the respective node 130a based on (in accordance with) correlation of each respective input 132a, . . . , 132c of the node 130a with the output 134a of that node 130a. Furthermore, each updating unit 150 is configured to apply a first function to the correlation if the associated node belongs to the first group 160 of the plurality of nodes and apply a second function, different from the first function, to the correlation if the associated node belongs to the second group 162 of the plurality of nodes in order to update the weights Wa, Wb, Wc during the learning mode (as an example for the node 130a and also applicable to all other nodes 130b, . . . , 130x). In some embodiments, the first (learning) function is a function in which if the input, i.e., the correlation (value), is increased, the output, i.e., a weight change (value) is exponentially increased and vice versa (decreased input gives exponentially decreased output). In some embodiments, the second (learning) function is a function in which if the input, i.e., the correlation (value), is increased, the output, i.e., a weight change (value) is exponentially decreased and vice versa (decreased input gives exponentially increased output).

In some embodiments, the data processing system 100 is configured to, after updating of the weights Wa, . . . , Wy has been performed, calculate a population variance of the outputs 134a, 134b, . . . , 134x of the nodes 130a, 130b, . . . , 130x of the network, compare the calculated population variance to a power law; and minimize an error, such as a mean absolute error or a mean squared error, between the population and the power law by adjusting parameters of the network. Thus, the population variance of the outputs 134a, 134b, . . . , 134x of the nodes 130a, 130b, . . . , 130x of the network may be distributed closely to the power law. Thereby, optimal resource utilization is achieved and/or every node is enabled to contribute optimally, thus providing more efficient utilization of data. The power law, may, for example, be based on (in accordance with) the log of the amount of variance explained against the log of number of components resulting from a principal component analysis. In another example, a power law is based on (in accordance with) a principal component analysis of limited time vectors of activity/output across all neurons, where each principal component number in the abscissa is replaced with node number. It is assumed that the input data that the system is exposed to has a higher number of principal components than there are nodes. In such case, when a power law is followed, each added node to the system potentially extends the maximal capacity of the system. Examples of parameters (that can be adjusted) for the network include: the type of scaling of the learning (how the weights are composed, the range of the weights or similar), induced change in synaptic weight when updated (e.g., exponentially, linearly), the amount of gain in the learning, one or more time constants of the state memory of the nodes or of each of the nodes, the specific learning functions (e.g., the first and/or second functions), the transfer functions for each node, the total capacity of the connections between nodes and sensors, the total capacity of nodes across all nodes.

Furthermore, in some embodiments, the data processing system 100 is configured to from the sensor data learn to identify one or more (unidentified) entities or a (unidentified) measurable characteristic (or measurable characteristics) thereof while in a learning mode and thereafter configured to identify the one or more entities or a measurable characteristic (or measurable characteristics) thereof while in a performance mode, e.g., from sensor data. In some embodiments, the identified entity is one or more of a speaker, a spoken letter, syllable, phoneme, word, or phrase present in the (audio) sensor data. Alternatively, or additionally, the identified entity is one or more objects or one or more features of an object present in sensor data (e.g., pixels). As another alternative, or additionally, the identified entity is a new contact event, the end of a contact event, a gesture, or an applied pressure present in the (touch) sensor data. Although, in some embodiments, all the sensor data is a specific type of sensor data, such as audio sensor data, image sensor data or touch sensor data, in other embodiments, the sensor data is a mix of different types of sensor data, such as audio sensor data, image sensor data and touch sensor data, i.e., the sensor data comprises different modalities. In some embodiments, the data processing system 100 is configured to from the sensor data learn to identify a measurable characteristic (or measurable characteristics) of an entity. A measurable characteristic may be a feature of an object, a part of a feature, a temporally evolving trajectory of positions, a trajectory of applied pressures, or a frequency signature or a temporally evolving frequency signature of a certain speaker when speaking a certain letter, syllable, phoneme, word, or phrase. Such a measurable characteristic may then be mapped to an entity. For example, a feature of an object may be mapped to an object, a part of a feature may be mapped to a feature (of an object), a trajectory of positions may be mapped to a gesture, a trajectory of applied pressures may be mapped to a (largest) applied pressure, a frequency signature of a certain speaker may be mapped to the speaker, and a spoken letter, syllable, phoneme, word or phrase may be mapped to an actual letter, syllable, phoneme, word or phrase. Such mapping may simply be a look up in a memory, a look up table or a database. The look up may be based on (in accordance with) finding the entity of a plurality of physical entities that has the characteristic, which is closest to the measurable characteristic identified. From such a look up, the actual entity may be identified. Furthermore, the data processing system 100 may be utilized in a warehouse, e.g., as part of a fully automatic warehouse (machine), in robotics, e.g., connected to robotic actuators (or robotics control circuits) via middleware (for connecting the data processing system 100 to the actuators), or in a system together with low complexity event-based cameras, whereby triggered data from the event-based cameras may be directly fed/sent to the data processing system 100.

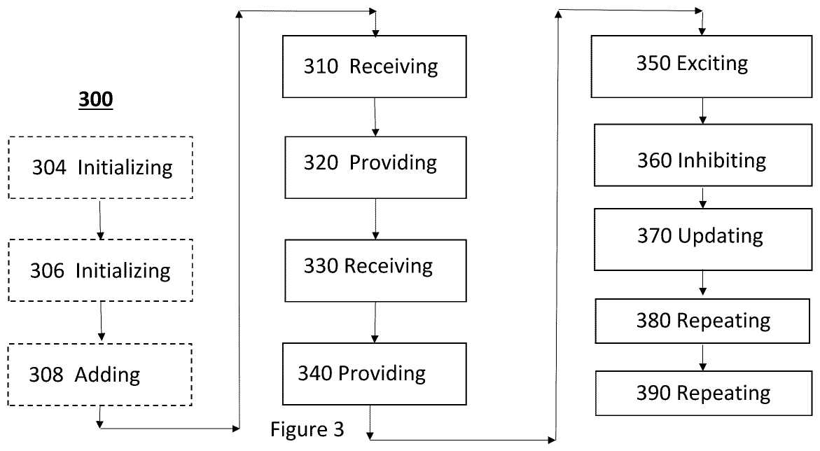

FIG. 3 is a flowchart illustrating example method steps according to some embodiments. FIG. 3 shows a computer-implemented or hardware-implemented method 300 for processing data. The method may be implemented in analog hardware/electronics circuit, in digital circuits, e.g., gates and flipflops, in mixed signal circuits, in software and in any combination thereof. In some embodiments, the method 300 comprises entering a learning mode. Alternatively, the method 300 comprises providing an already trained data processing system 100. In this case, the steps 370 and 380 (steps g and h) are not performed. The method 300 comprises receiving 310 one or more system inputs 110a, 110b, . . . , 110z comprising data to be processed. Furthermore, the method 300 comprises providing 320 a plurality of inputs 132a, 132b, . . . , 132y, at least one of the plurality of inputs being a system input, to a network, NW, 130 comprising a plurality of first nodes 130a, 130b, . . . , 130x. Moreover, the method 300 comprises receiving 330 an output 134a, 134b, . . . , 134x from each first node 130a, 130b, . . . , 130x. The method 300 comprises providing 340 a system output 120 comprising the output 34a, 134b, . . . , 134x of each first node 130a, 130b, . . . , 130x. Furthermore, the method 300 comprises exciting 350, by nodes 130a, 130b of a first group 160 of the plurality of nodes, one or more other nodes . . . , 130x of the plurality of nodes 130a, 130b, . . . , 130x by providing the output 134a, 134b of each of the nodes 130a, 130b of the first group 160 of nodes as input 132d, . . . , 132y to the one or more other nodes . . . , 130x. Moreover, the method 300 comprises inhibiting 360, by nodes 130x of a second group 162 of the plurality of nodes, one or more other nodes 130a, 130b, . . . of the plurality of nodes 130a, 130b, . . . , 130x by providing the output 134x of each of the nodes 130x of the second group 162 as a processing unit input 142x to a respective processing unit 140x, each respective processing unit 140x being configured to provide the processing unit output 144x as input 132b, 132e, . . . to the one or more other nodes 130a, 130b, . . . . The method 300 comprises updating 370, by one or more updating units 150, weights Wa, . . . , Wy based on (in accordance with) correlation (during the learning mode and as described in connection with FIGS. 1 and 2 above). Furthermore, the method 300 comprises repeating 380 (during the learning mode) the steps 310, 320, 330, 340, 350, 360 and 370 (described above) until a learning criterion is met (thus exiting the learning mode when the learning criterion is met). In some embodiments, the learning criterion is that the data processing the system 100 is fully trained. In some embodiments, the learning criterion is that the weights Wa, Wb, . . . , Wy converge and/or that an overall error goes below an error threshold. In some embodiments, the method 300 comprises entering a performance/identification mode. Moreover, the method 300 comprises repeating 390 (during the performance/identification mode) the steps 310, 320, 330, 340, 350 and 360 (described above) until a stop criterion is met (thus exiting the performance/identification mode when the stop criterion is met). A stop criterion/condition may be that all data to be processed have been processed or that a specific amount of data/number of loops have been processed/performed. Alternatively, the stop criterion is that the whole data processing system 100 is turned off. As another alternative, the stop criterion is that the data processing system 100 (or a user of the system 100) has discovered that the data processing system 100 needs to be further trained. In this case, the data processing system 100 enters/re-enters the learning mode (and performs the steps 310, 320, 330, 340, 350, 360, 370, 380 and 390). Each node of the plurality of nodes 130a, 130b, . . . , 130x belongs to one of the first and second groups 160, 162 of nodes.

In some embodiments, the method 300 comprises initializing 304 weights Wa, . . . , Wy by setting the weights Wa, . . . , Wy to zero. Alternatively, the method 300 comprises initializing 306 the weights Wa, . . . , Wy by randomly allocating values between 0 and 1 to the weights Wa, . . . , Wy. Furthermore, in some embodiments the method 300 comprises adding 308 a predetermined waveform to the output 134a, 134b, . . . , 134x of one or more of the plurality of nodes 130a, 130b, . . . , 130x for the duration of a third time period. In some embodiments, the third time period starts simultaneously with receiving 310 one or more system inputs 110a, 110b, . . . , 110z comprising data to be processed.

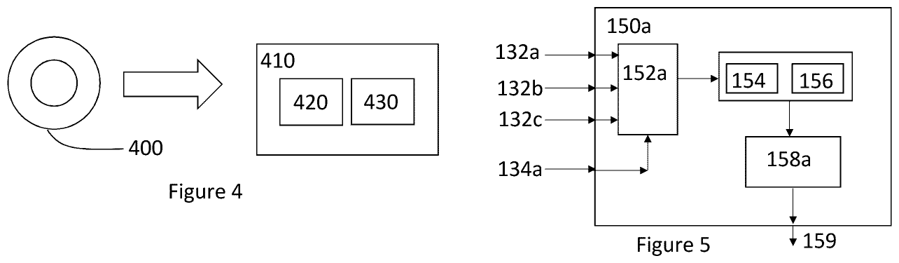

According to some embodiments, a computer program product comprises a non-transitory computer readable medium 400 such as, for example a universal serial bus (USB) memory, a plug-in card, an embedded drive, a digital versatile disc (DVD) or a read only memory (ROM). FIG. 4 illustrates an example computer readable medium in the form of a compact disc (CD) ROM 400. The computer readable medium has stored thereon, a computer program comprising program instructions. The computer program is loadable into a data processor (PROC) 420, which may, for example, be comprised in a computer or a computing device 410. When loaded into the data processing unit, the computer program may be stored in a memory (MEM) 430 associated with or comprised in the data-processing unit. According to some embodiments, the computer program may, when loaded into and run by the data processing unit, cause execution of method steps according to, for example, the method illustrated in FIG. 3, which is described herein. Furthermore, in some embodiments, there is provided a computer program product comprising instructions, which, when executed on at least one processor of a processing device, cause the processing device to carry out the method illustrated in FIG. 3. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 3.

FIG. 5 illustrates an updating unit according to some embodiments. The updating unit 150a is for the node 130a. However, all updating units 150, 150a (for all nodes) are the same or similar. The updating unit 150a receives each respective input 132a, . . . , 132c of the node 130a (or of all nodes if it is a central updating unit 150). Furthermore, the updating unit 150a receives the output 134a of the node 130a (or of all nodes if it is a central updating unit 150). Moreover, the updating unit 150a comprises a correlator 152a. The correlator 152a calculates correlation of each respective input 132a, . . . , 132c of the node 130a with the corresponding output (134a) during a learning mode, thus producing (a series of) correlation values for each of the inputs 132a, . . . , 132c. In some embodiments, the different calculated (series of) correlation values are compared to each other (to produce correlation ratio values) and the updating of weights is based on (in accordance with) this comparison. Furthermore, in some embodiments, the updating unit 150a is configured to apply a first function 154 to the correlation (values, ratio values) if the node (130a) belongs to the first group 160 of the plurality of nodes and apply a second function 156, different from the first function, to the correlation (values, ratio values) if the node (130a) belongs to the second group 162 of the plurality of nodes in order to update the weights Wa, Wb, Wc during the learning mode. In some embodiments, the updating unit 150a keeps track on whether a node belongs to the first or second group 160, 162 by utilizing lock-up tables (LUTs). Moreover, in some embodiments, the updating unit 150a comprises, for each weight Wa, Wb, Wc, a probability value Pa, Pb, Pc for increasing the weight. In some embodiments, the updating unit 150a comprises, for each weight Wa, Wb, Wc, a probability value Pad, Pbd, Pcd for decreasing the weight which in some embodiments is 1−Pa, 1−Pb, 1−Pc, i.e., Pad=1−Pa, Pbd=1−Pb and Pcd=1−Pc). In some embodiments, the probability values Pa, Pb, Pc and optionally the probability values Pad, Pbd, Pcd are comprised in a memory unit 158a of the updating unit 150a. In some embodiments, the memory unit 158a is a lock-up table (LUT). In some embodiments, the updating unit 150a applies one of the first and second functions and/or the probability values Pa, Pb, Pc and optionally the probability values Pad, Pbd, Pcd to the calculated (series of) correlation values (or the produced correlation ratio values) to obtain an update signal 159, which is then applied to the weights Wa, Wb, Wc, thereby updating the weights Wa, Wb, Wc. The function/structure of update units for other nodes 150b, . . . , 150x is the same as for the node 150a. Furthermore, in some embodiments, a central updating unit 150 comprises each of the updating units for each of the nodes 130a, 130b, . . . , 130x.

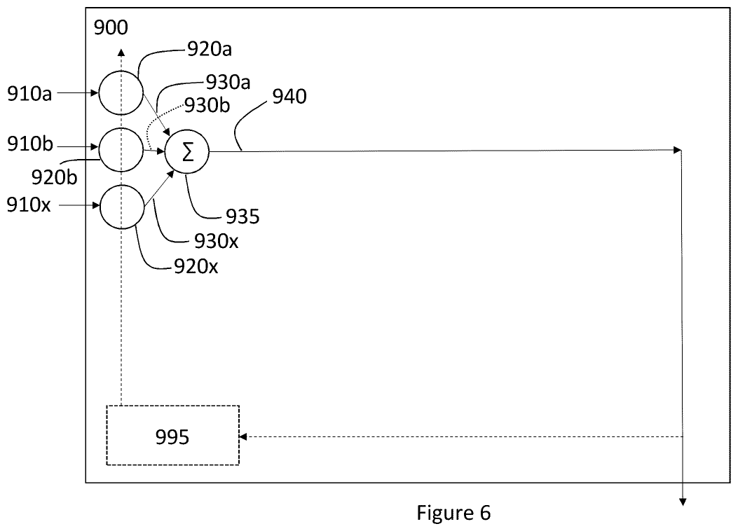

FIG. 6 illustrates a compartment according to some embodiments. In some embodiments, each node 130a, 130b, . . . , 130x comprises a plurality of compartments 900. Each compartment is configured to have a plurality of compartment inputs 910a, 910b, . . . , 910x. Furthermore, each compartment 900 comprises a compartment weight 920a, 920b, . . . , 920x for each compartment input 910a, 910b, . . . , 910x. Moreover, each compartment 900 is configured to produce a compartment output 940. The compartment output 940 is in some embodiments calculated, by the compartment, as a combination, such as a sum, of all weighted compartment inputs 930a, 930b, . . . , 930x to that compartment. For calculating the sum/combination, the compartment may be equipped with a summer (or adder/summation unit) 935. Each compartment 900 comprises an updating unit 995 configured to update the compartment weights 920a, 920b, . . . , 920x based on (in accordance with) correlation during the learning mode (in the same manner as described for the updating unit 150a above in connection with FIG. 5 and elsewhere and may for one or more compartments comprise evaluating each input of a node based on a score function). Furthermore, the compartment output 940 of each compartment is utilized to adjust the output 134a, 134b, . . . , 134x (e.g., 134a) of the node 130a, 130b, . . . , 130x (e.g., 130a) the compartment 900 is comprised in based on (in accordance with) a transfer function. Examples of transfer functions that can be utilized are one or more of a time constant, such as an RC filter, a resistor, a spike generator, and an active element, such as a transistor or an op-amp. The compartments 900a, 900b, . . . , 900x may comprise sub-compartments 900aa, 900ab, . . . , 900ba, 900bb, . . . , 900xx. Thus, each compartment 900a, 900b, . . . , 900x may have sub-compartments 900aa, 900ab, . . . , 900ba, 900bb, sub-sub-compartments etc., which functions in the same manner as the compartments, i.e., the compartments are cascaded. The number of compartments (and sub-compartments) for a specific node is based on (in accordance with) the types of inputs, such as inhibitory input, sensor input and excitatory input, to that specific node. Furthermore, the compartments 900 of a node are arranged so that each compartment 900 has a majority of one of the types of input (e.g., inhibitory input, sensor input or excitatory input). Thus, none of the types of input (e.g., inhibitory input, sensor input or excitatory input) is allowed to become too dominant.

In some embodiments, still referring to FIG. 6, the updating unit 995 of each compartment 900 comprises, for each compartment weight 920a, 920b, . . . , 920x, a probability value PCa, . . . , PCy for increasing the weight (and possibly a probability value PCad, . . . , PCyd for decreasing the weight which in some embodiments is 1−PCa, . . . , 1−PCy, i.e., PCad=1−PCa, PCbd=1−PCb etc.). In these embodiments, during the learning mode, the data processing system 100 is configured to provide a third set point for a sum of all compartment weights 920a, 920b, . . . , 920x associated with the compartment inputs 910a, 910b, . . . , 910x to a compartment 900, configured to calculate the sum of all compartment weights 920a, 920b, . . . , 920x associated with the compartment inputs 910a, 910b, . . . , 910x to the compartment 900, configured to compare the calculated sum to the third set point and if the calculated sum is greater than the third set point, configured to decrease the probability values PCa, . . . , PCy associated with the compartment weights 920a, 920b, . . . , 920x for (associated with) the compartment inputs 910a, 910b, . . . , 910x to the compartment 900 and if the calculated sum is smaller than the third set point, configured to increase the probability values PCa, . . . , PCy associated with the weights 920a, 920b, . . . , 920x for (associated with) the compartment inputs 910a, 910b, . . . , 910x to the compartment 900. The third set point is based on (in accordance with) a type of input, such as system input (sensor input), input from a node of the first group 160 of the plurality of nodes (excitatory input) or input from a node of the second group 162 of the plurality of nodes (inhibitory input).

In some embodiments, the data processing system 100 is a time-continuous data processing system, i.e., all signals, including signals between different nodes and including the one or more system inputs 110a, 110b, . . . , 110z and the system output 120, within the data processing system 100 are time-continuous (e.g., without spikes).

### List of Examples

Example 1. A data processing system (100), configured to have one or more system input(s) (110a, 110b, . . . , 110z) comprising data to be processed and a system output (120), comprising:
a network, NW, (130) comprising a plurality of nodes (130a, 130b, . . . , 130x), each node configured to have a plurality of inputs (132a, 132b, . . . , 132y), each node (130a, 130b, . . . , 130x) comprising a weight (Wa, . . . , Wy) for each input (132a, 132b, . . . , 132y), and each node configured to produce an output (134a, 134b, . . . , 134x); and one or more updating units (150) configured to update the weights (Wa, . . . , Wy) of each node based on correlation of each respective input (132a, . . . , 132c) of the node (130a) with the corresponding output (134a) during a learning mode;
one or more processing units (140x) configured to receive a processing unit input and configured to produce a processing unit output by changing the sign of the received processing unit input; and
wherein the system output (120) comprises the outputs (134a, 134b, . . . , 134x) of each node (130a, 130b, . . . , 130x),
wherein nodes (130a, 130b) of a first group (160) of the plurality of nodes are configured to excite one or more other nodes ( . . . , 130x) of the plurality of nodes (130a, 130b, . . . , 130x) by providing the output (134a, 134b) of each of the nodes (130a, 130b) of the first group (160) of nodes as input (132d, . . . , 132y) to the one or more other nodes ( . . . , 130x),
wherein nodes (130x) of a second group (162) of the plurality of nodes are configured to inhibit one or more other nodes (130a, 130b, . . . ) of the plurality of nodes (130a, 130b, . . . , 130x) by providing the output (134x) of each of the nodes (130x) of the second group (162) as a processing unit input to a respective processing unit (140x), each respective processing unit (140x) being configured to provide the processing unit output as input (132b, 132e, . . . ) to the one or more other nodes (130a, 130b, . . . ) and
wherein each node of the plurality of nodes (130a, 130b, . . . , 130x) belongs to one of the first and second groups (160, 162) of nodes.

Example 2. The data processing system of example 1, wherein the system input(s) comprises sensor data of a plurality of contexts/tasks.

Example 3. The data processing system of any of examples 1-2, wherein the updating unit 150 comprises, for each weight (Wa, . . . , Wy), a probability value (Pa, . . . , Py) for increasing the weight, and wherein, during the learning mode, the data processing system is configured to limit the ability of a node (130a) to inhibit or excite the one or more other nodes (130b, . . . , 130x) by providing a first set point for a sum of all weights (Wd, Wy) associated with the inputs (132d, . . . , 132y) to the one or more other nodes (130b, . . . , 130x), comparing the first set point to the sum of all weights (Wd, Wy) associated with the inputs (132d, . . . , 132y) to the one or more other nodes (130b, . . . , 130x), if the first set point is smaller than the sum of all weights (Wd, Wy) associated with the inputs (132d, . . . , 132y) to the one or more other nodes (130b, . . . , 130x) decreasing the probability values (Pd, Py) associated with the weights (Wd, Wy) associated with the inputs (132d, . . . , 132y) to the one or more other nodes (130b, . . . , 130x) and if the first set point is greater than the sum of all weights (Wd, Wy) associated with the inputs (132d, . . . , 132y) to the one or more other nodes (130b, . . . , 130x) increasing the probability values (Pd, Py) associated with the weights (Wd, Wy) associated with the inputs (132d, . . . , 132y) to the one or more other nodes (130b, . . . , 130x).

Example 4. The data processing system of any of examples 1-3, wherein, during the learning mode, the data processing system is configured to limit the ability of a system input (110z) to inhibit or excite one or more nodes (130a, . . . , 130x) by providing the first set point for a sum of all weights (Wg, Wx) associated with the inputs (132g, 132x) to the one or more nodes (130a, . . . , 130x), comparing the first set point to the sum of all weights (Wg, Wx) associated with the inputs (132g, 132x) to the one or more nodes (130a, . . . , 130x), if the first set point is smaller than the sum of all weights (Wg, Wx) associated with the inputs (132g, 132x) to the one or more nodes (130a, . . . , 130x) decreasing the probability values (Pg, Px) associated with the weights (Wg, Wx) associated with the inputs (132g, 132x) to the one or more nodes (130a, . . . , 130x) and if the first set point is greater than the sum of all weights (Wg, Wx) associated with the inputs (132g, 132x) to the one or more nodes (130a, . . . , 130x) increasing the probability values (Pg, Px) associated with the weights (Wg, Wx) associated with the inputs (132g, 132x) to the one or more nodes (130a, . . . , 130x).

Example 5. The data processing system of any of examples 3-4, wherein each of the inputs (132d, . . . , 132y) to the one or more other nodes (130b, . . . , 130x) has a coordinate in a network space, wherein an amount of decreasing/increasing the weights (Wd, Wy) of the inputs (132d, 132y) to the one or more other nodes (130b, . . . , 130x) is based on a distance between the coordinates of the inputs (132d, 132y) associated with the weights (Wd, Wy) in the network space.

Example 6. The data processing system of any of examples 3-5, wherein the system is further configured to set a weight (Wa, . . . , Wy) to zero if the weight (Wa, . . . , Wy) does not increase over a pre-set period of time; and/or
wherein the system is further configured to increase the probability value (Pa, . . . , Py) of a weight (Wa, . . . , Wy) having a zero value if the sum of all weights (Wd, Wy) associated with the inputs (132d, . . . , 132y) to the one or more other nodes (130b, . . . , 130x) does not exceed the first set point for a pre-set period of time.

Example 7. The data processing system of any of examples 1-2, wherein, during the learning mode, the data processing system is configured to increase the relevance of the output (134a) of a node (130a) to the one or more other nodes (130b, . . . , 130x) by providing a first set point for a sum of all weights (Wd, Wy) associated with the inputs (132d, . . . , 132y) to the one or more other nodes (130b, . . . , 130x), comparing the first set point to the sum of all weights (Wd, Wy) associated with the inputs (132d, . . . , 132y) to the one or more other nodes (130b, . . . , 130x) over a first time period, if the first set point is smaller than the sum of all weights (Wd, Wy) associated with the inputs (132d, . . . , 132y) to the one or more other nodes (130b, . . . , 130x) over the entire length of the first time period increasing the probability of changing the weights (Wa, Wb, Wc) of the inputs (132a, 132b, 132c) to the node (130a) and if the first set point is greater than the sum of all weights (Wd, Wy) associated with the inputs (132d, . . . , 132y) to the one or more other nodes (130b, . . . , 130x) over the entire length of the first time period decreasing the probability of changing the weights (Wa, Wb, Wc) of the inputs (132a, 132b, 132c) to the node (130a).

Example 8. The data processing system of any of examples 1-2, wherein the updating unit (150) comprises, for each weight (Wa, . . . , Wy), a probability value (Pa, . . . , Py) for increasing the weight, and wherein, during the learning mode, the data processing system is configured to provide a second set point for a sum of all weights (Wa, Wb, Wc) associated with the inputs (132a, 132b, 132c) to a node (130a), configured to calculate the sum of all weights (Wa, Wb, Wc) associated with the inputs (132a, 132b, 132c) to the node (130a), configured to compare the calculated sum to the second set point and if the calculated sum is greater than the second set point, configured to decrease the probability values (Pa, Pb, Pc) associated with the weights (Wa, Wb, Wc) associated with the inputs (132a, 132b, 132c) to the node (130a) and if the calculated sum is smaller than the second set point, configured to increase the probability values (Pa, Pb, Pc) associated with the weights (Wa, Wb, Wc) associated with the inputs (132a, 132b, 132c) to the node (130a).

Example 9. The data processing system of any of examples 1-2, wherein each node (130a, 130b, . . . , 130x) comprises a plurality of compartments (900) and each compartment being configured to have a plurality of compartment inputs (910a, 910b, . . . , 910x), each compartment (900) comprising a compartment weight (920a, 920b, . . . , 920x) for each compartment input (910a, 910b, . . . , 910x), and each compartment (900) being configured to produce a compartment output (940) and wherein each compartment (900) comprises an updating unit (995) configured to update the compartment weights (920a, 920b, . . . , 920x) based on correlation during the learning mode and wherein the compartment output (940) of each compartment is utilized to adjust the output (134a, 134b, . . . , 134x) of the node (130a, 130b, . . . , 130x) the compartment is comprised in based on a transfer function.

Example 10. The data processing system of example 9, wherein the updating unit (995) of each compartment (900) comprises, for each compartment weight (920a, 920b, . . . , 920x), a probability value (PCa, . . . , PCy) for increasing the weight, and wherein, during the learning mode, the data processing system is configured to provide a third set point for a sum of all compartment weights (920a, 920b, . . . , 920x) associated with the compartment inputs (910a, 910b, . . . , 910x) to a compartment (900), configured to calculate the sum of all compartment weights (920a, 920b, . . . , 920x) associated with the compartment inputs (910a, 910b, . . . , 910x) to the compartment (900), configured to compare the calculated sum to the third set point and if the calculated sum is greater than the third set point, configured to decrease the probability values (PCa, . . . , PCy) associated with the compartment weights (920a, 920b, . . . , 920x) associated with the compartment inputs (910a, 910b, . . . , 910x) to the compartment (900) and if the calculated sum is smaller than the third set point, configured to increase the probability values (PCa, . . . , PCy) associated with the weights (920a, 920b, . . . , 920x) associated with the compartment inputs (910a, 910b, . . . , 910x) to the compartment (900) and wherein the third set point is based on a type of input, such as system input, input from a node of the first group (160) of the plurality of nodes or input from a node of the second group (162) of the plurality of nodes.

Example 11. The data processing system of any of examples 1-2, wherein during the learning mode, the data processing system is configured to:
detect whether the network (130) is sparsely connected by comparing an accumulated weight change for the system input(s) (110a, 110b, . . . , 110z) over a second time period to a threshold value; and
if the data processing system detects that the network (130) is sparsely connected, increase the output (134a, 134b, . . . , 134x) of one or more of the plurality of nodes (130a, 130b, . . . , 130x) by adding a predetermined waveform to the output (134a, 134b, . . . , 134x) of one or more of the plurality of nodes (130a, 130b, . . . , 130x) for the duration of a third time period.

Example 12. The data processing system of any of examples 1-11, wherein each node comprises an updating unit (150), wherein each updating unit (150) is configured to update the weights (Wa, Wb, Wc) of the respective node (130a) based on correlation of each respective input (132a, . . . , 132c) of the node (130a) with the output (134a) of that node (130a) and wherein each updating unit (150) is configured to apply a first function to the correlation if the associated node belongs to the first group (160) of the plurality of nodes and apply a second function, different from the first function, to the correlation if the associated node belongs to the second group (162) of the plurality of nodes in order to update the weights (Wa, Wb, Wc) during the learning mode.

Example 13. The data processing system of any of examples 1-12, wherein the data processing system is configured to, after updating of the weights (Wa, . . . , Wy) has been performed, calculate a population variance of the outputs (134a, 134b, . . . , 134x) of the nodes (130a, 130b, . . . , 130x) of the network, compare the calculated population variance to a power law; and minimizing an error or a mean squared error between the population and the power law by adjusting parameters of the network.

Example 14. The data processing system of any of examples 2-13, wherein the data processing system is configured to from the sensor data learn to identify one or more entities while in a learning mode and thereafter configured to identify the one or more entities while in a performance mode and wherein the identified entity is one or more of a speaker, a spoken letter, syllable, phoneme, word or phrase present in the sensor data or an object or a feature of an object present in sensor data or a new contact event, an end of a contact event, a gesture or an applied pressure present in the sensor data.

Example 15. A computer-implemented or hardware-implemented method (300) for processing data, comprising:
a) receiving (310) one or more system input(s) (110a, 110b, . . . , 110z) comprising data to be processed;
b) providing (320) a plurality of inputs (132a, 132b, . . . , 132y), at least one of the plurality of inputs being a system input, to a network, NW, (130) comprising a plurality of first nodes (130a, 130b, . . . , 130x);
c) receiving (330) an output (134a, 134b, . . . , 134x) from each first node (130a, 130b, . . . , 130x);
d) providing (340) a system output (120), comprising the output (134a, 134b, . . . , 134x) of each first node (130a, 130b, . . . , 130x);
e) exciting (350), by nodes (130a, 130b) of a first group (160) of the plurality of nodes, one or more other nodes ( . . . , 130x) of the plurality of nodes (130a, 130b, . . . , 130x) by providing the output (134a, 134b) of each of the nodes (130a, 130b) of the first group (160) of nodes as input (132d, . . . , 132y) to the one or more other nodes ( . . . , 130x);
f) inhibiting (360), by nodes (130x) of a second group (162) of the plurality of nodes, one or more other nodes (130a, 130b, . . . ) of the plurality of nodes (130a, 130b, . . . , 130x) by providing the output (134x) of each of the nodes (130x) of the second group (162) as a processing unit input to a respective processing unit (140x), each respective processing unit (140x) being configured to provide the processing unit output as input (132b, 132e, . . . ) to the one or more other nodes (130a, 130b, . . . ); and
g) optionally updating (370), by one or more updating units (150), weights (Wa, . . . , Wy) based on correlation; and
h) optionally repeating (380) a)-g) until a learning criterion is met;
i) repeating (390) a)-f) until a stop criterion is met, and
wherein each node of the plurality of nodes (130a, 130b, . . . , 130x) belongs to one of the first and second groups (160, 162) of nodes.

Example 16. The method of example 15, further comprising:
initializing (304) weights (Wa, . . . , Wy) by setting the weights (Wa, . . . , Wy) to zero; and
adding (308) a predetermined waveform to the output (134a, 134b, . . . , 134x) of one or more of the plurality of nodes (130a, 130b, . . . , 130x) for the duration of a third time period, the third time period starting at the same time receiving (310) one or more system input(s) (110a, 110b, . . . , 110z) comprising data to be processed starts.

Example 17. The method of example 15, further comprising:
initializing (306) weights (Wa, . . . , Wy) by randomly allocating values between 0 and 1 to the weights (Wa, . . . , Wy); and
adding (308) a predetermined waveform to the output (134a, 134b, . . . , 134x) of one or more of the plurality of nodes (130a, 130b, . . . , 130x) for the duration of a third time period.

Example 18. A computer program product comprising a non-transitory computer readable medium (400), having stored thereon a computer program comprising program instructions, the computer program being loadable into a data processing unit (420) and configured to cause execution of the method according to any of examples 15-17 when the computer program is run by the data processing unit (420).

The person skilled in the art realizes that the present disclosure is not limited to the preferred embodiments described above. The person skilled in the art further realizes that modifications and variations are possible within the scope of the appended claims. For example, signals from other sensors, such as aroma sensors or flavor sensors may be processed by the data processing system. Moreover, the data processing system described may equally well be utilized for unsegmented, connected handwriting recognition, speech recognition, speaker recognition and anomaly detection in network traffic or intrusion detection systems (IDSs). Additionally, variations to the disclosed embodiments can be understood and effected by the skilled person in practicing the claimed disclosure, from a study of the drawings, the disclosure, and the appended claims.

1. A data processing system, configured to have one or more system inputs comprising data to be processed and a system output, comprising:
a network, NW, comprising a plurality of nodes, each node being configured to have a plurality of inputs, each node comprising a weight for each input, and each node configured to produce an output; and
one or more processing units configured to receive a processing unit input and configured to produce a processing unit output by changing the sign of the received processing unit input; and
wherein the system output comprises the outputs of each node,
wherein nodes of a first group of the plurality of nodes are configured to excite one or more other nodes of the plurality of nodes by providing the output of each of the nodes of the first group of nodes as input to the one or more other nodes,
wherein nodes of a second group of the plurality of nodes are configured to inhibit one or more other nodes of the plurality of nodes by providing the output of each of the nodes of the second group as a processing unit input to a respective processing unit, each respective processing unit being configured to provide the processing unit output as input to the one or more other nodes,
wherein each node of the plurality of nodes belongs to one of the first and second groups of nodes,
wherein each node comprises an updating unit, wherein each updating unit is configured to update the weights of the respective node based on correlation of each respective input of the node with the output of that node, and
wherein each updating unit is configured to apply a first function to the correlation if the associated node belongs to the first group of the plurality of nodes and apply a second function, different from the first function, to the correlation if the associated node belongs to the second group of the plurality of nodes in order to update the weights during the learning mode.

2. The data processing system of claim 1, wherein the one or more system inputs comprises sensor data of a plurality of contexts/tasks.

3. The data processing system of claim 1, wherein the updating unit comprises, for each weight, a probability value for increasing the weight, and wherein, during the learning mode, the data processing system is configured to limit the ability of a node to inhibit or excite the one or more other nodes by providing a first set point for a sum of all weights associated with the inputs to the one or more other nodes, comparing the first set point to the sum of all weights associated with the inputs to the one or more other nodes, if the first set point is smaller than the sum of all weights associated with the inputs to the one or more other nodes decreasing the probability values associated with the weights associated with the inputs to the one or more other nodes and if the first set point is greater than the sum of all weights associated with the inputs to the one or more other nodes increasing the probability values associated with the weights associated with the inputs to the one or more other nodes.

4. The data processing system of claim 1, wherein, during the learning mode, the data processing system is configured to limit the ability of a system input to inhibit or excite one or more nodes by providing the first set point for a sum of all weights associated with the inputs to the one or more nodes, comparing the first set point to the sum of all weights associated with the inputs to the one or more nodes, if the first set point is smaller than the sum of all weights associated with the inputs to the one or more nodes decreasing the probability values associated with the weights associated with the inputs to the one or more nodes and if the first set point is greater than the sum of all weights associated with the inputs to the one or more nodes increasing the probability values associated with the weights associated with the inputs to the one or more nodes.

5. The data processing system of claim 3, wherein each of the inputs to the one or more other nodes has a coordinate in a network space, wherein an amount of decreasing/increasing the weights of the inputs to the one or more other nodes is based on a distance between the coordinates of the inputs associated with the weights in the network space.

6. The data processing system of claim 3, wherein the system is further configured to set a weight to zero if the weight does not increase over a pre-set period of time; and/or
wherein the system is further configured to increase the probability value of a weight having a zero value if the sum of all weights associated with the inputs to the one or more other nodes does not exceed the first set point for a pre-set period of time.

7. The data processing system of claim 1, wherein, during the learning mode, the data processing system is configured to increase the relevance of the output of a node to the one or more other nodes by providing a first set point for a sum of all weights associated with the inputs to the one or more other nodes, comparing the first set point to the sum of all weights associated with the inputs to the one or more other nodes over a first time period, if the first set point is smaller than the sum of all weights associated with the inputs to the one or more other nodes over the entire length of the first time period increasing the probability of changing the weights of the inputs to the node and if the first set point is greater than the sum of all weights associated with the inputs to the one or more other nodes over the entire length of the first time period decreasing the probability of changing the weights of the inputs to the node.

8. The data processing system of claim 1, wherein the updating unit comprises, for each weight, a probability value for increasing the weight, and wherein, during the learning mode, the data processing system is configured to provide a second set point for a sum of all weights associated with the inputs to a node, configured to calculate the sum of all weights associated with the inputs to the node, configured to compare the calculated sum to the second set point and if the calculated sum is greater than the second set point, configured to decrease the probability values associated with the weights associated with the inputs to the node and if the calculated sum is smaller than the second set point, configured to increase the probability values associated with the weights associated with the inputs to the node.

9. The data processing system of claim 1, wherein each node comprises a plurality of compartments and each compartment being configured to have a plurality of compartment inputs, each compartment comprising a compartment weight for each compartment input, and each compartment being configured to produce a compartment output and wherein each compartment comprises an updating unit configured to update the compartment weights based on correlation during the learning mode and wherein the compartment output of each compartment is utilized to adjust the output of the node the compartment is comprised in based on a transfer function.

10. The data processing system of claim 9, wherein the updating unit of each compartment comprises, for each compartment weight, a probability value for increasing the weight, and wherein, during the learning mode, the data processing system is configured to provide a third set point for a sum of all compartment weights associated with the compartment inputs to a compartment, configured to calculate the sum of all compartment weights associated with the compartment inputs to the compartment, configured to compare the calculated sum to the third set point and if the calculated sum is greater than the third set point, configured to decrease the probability values associated with the compartment weights associated with the compartment inputs to the compartment and if the calculated sum is smaller than the third set point, configured to increase the probability values associated with the weights associated with the compartment inputs to the compartment and wherein the third set point is based on a type of input, such as system input, input from a node of the first group of the plurality of nodes or input from a node of the second group of the plurality of nodes.

11. The data processing system of claim 1, wherein during the learning mode, the data processing system is configured to:
detect whether the network is sparsely connected by comparing an accumulated weight change for the one or more system inputs over a second time period to a threshold value; and
if the data processing system detects that the network is sparsely connected, increase the output of one or more of the plurality of nodes by adding a predetermined waveform to the output of one or more of the plurality of nodes for the duration of a third time period.

12. The data processing system of claim 1, wherein the data processing system is configured to, after updating of the weights has been performed, calculate a population variance of the outputs of the nodes of the network, compare the calculated population variance to a power law; and minimizing an error or a mean squared error between the population and the power law by adjusting parameters of the network.

13. The data processing system of claim 12, wherein adjusting parameters of the network comprises adjusting one or more of:
a type of scaling of the learning, such as a range of the weights;
an induced change in synaptic weight when updated, such as exponentially or linearly;
an amount of gain in the learning;
one or more time constants of the state memory of each of the nodes;
one or more learning functions, such as the first and second functions;
a transfer function for each node;
a total capacity of the connections between nodes and sensors; and
a total capacity of nodes across all nodes.

14. The data processing system of claim 2, wherein the data processing system is configured to from the sensor data learn to identify one or more entities while in a learning mode and thereafter configured to identify the one or more entities while in a performance mode.

15. The data processing system of claim 14, wherein the identified entity is one or more of a speaker, a spoken letter, syllable, phoneme, word or phrase present in the sensor data.

16. The data processing system of claim 14, wherein the identified entity is an object or a feature of an object present in sensor data.

17. The data processing system of claim 14, wherein the identified entity is a new contact event, an end of a contact event, a gesture or an applied pressure present in the sensor data.

18. The data processing system of claim 1, wherein the network is a recurrent neural network.

19. The data processing system of claim 1, wherein the network is a recursive neural network.

20. A computer-implemented or hardware-implemented method for processing data, comprising:
receiving one or more system inputs comprising data to be processed;
providing a plurality of inputs, at least one of the plurality of inputs being a system input, to a network, NW, comprising a plurality of first nodes;
receiving an output from each first node;
providing a system output, comprising the output of each first node;
exciting, by nodes of a first group of the plurality of nodes, one or more other nodes of the plurality of nodes by providing the output of each of the nodes of the first group of nodes as input to the one or more other nodes;
inhibiting, by nodes of a second group of the plurality of nodes, one or more other nodes of the plurality of nodes by providing the output of each of the nodes of the second group as a processing unit input to a respective processing unit, each respective processing unit being configured to provide the processing unit output as input to the one or more other nodes; and
updating, for each node, the weights based on correlation of each respective input of the node with the output of that node and applying a first function to the correlation if the associated node belongs to the first group of the plurality of nodes and apply a second function, different from the first function, to the correlation if the associated node belongs to the second group of the plurality of nodes in order to update the weights during the learning mode,
wherein each node of the plurality of nodes belongs to one of the first and second groups of nodes.

21. The method of claim 20, further comprising:
repeating the steps of receiving one or more system inputs, providing a plurality of inputs, receiving an output, providing a system output, exciting, inhibiting, and updating until a learning criterion is met.

22. The method of claim 20, further comprising:
repeating the steps of receiving one or more system inputs, providing a plurality of inputs, receiving an output, providing a system output, exciting and inhibiting until a stop criterion is met.

23. The method of claim 20, further comprising:
initializing weights by setting the weights to zero; and
adding a predetermined waveform to the output of one or more of the plurality of nodes for the duration of a third time period, the third time period starting at the same time receiving one or more system inputs comprising data to be processed starts.

24. The method of claim 20, further comprising:
initializing weights by randomly allocating values between 0 and 1 to the weights; and
adding a predetermined waveform to the output of one or more of the plurality of nodes for the duration of a third time period.

25. A computer program product comprising instructions, which, when executed on at least one processor of a processing device, cause the processing device to carry out the method according to claim 20.

26. A non-transitory computer-readable storage medium storing one or more programs configured to be executed by one or more processors of a processing device, the one or more programs comprising instructions which, when executed by the processing device, causes the processing device to carry out the method according to claim 20.
